(19) United States
(12) Patent Application Publication
(10) Pub. No.: US 2010/0206590 A1
(43) Pub. Date: Aug. 19, 2010

(54) LONG HANDLED GARDENING TOOL

(76) Inventor: Daniel Rodriguez, San Pedro, CA (US)

Correspondence Address: Daniel Rodriguez, 3717 S. Cabrillo Ave., San Pedro, CA, 90731, US

(21) Appl. No.: 12/708,260

(22) Filed: Feb. 18, 2010

Related U.S. Application Data
(60) Provisional application No. 61/153,706, filed on Feb. 19, 2009.

(51) Int. Cl. A01B 1/00

(52) U.S. Cl. 172/371

(57) ABSTRACT

A gardening and landscaping tool may include a handle attached to a blade, with the blade being bent at an angle relative to the handle. The tool may be useful for removing weeds, unwanted grass, plants, and the like. The tool may use a pushing/sliding force to slide the blade at or just below the surface. The blade may include a sharp edge that may cut through the ground with ease.

### CROSS-REFERENCE TO RELATED APPLICATIONS

This application claims the benefit of U.S. provisional Application No. 61/153,706, filed Feb. 19, 2009.

### BACKGROUND OF THE INVENTION

The present invention generally relates to a gardening tool and more specifically, to a gardening tool having a long handle with an angled blade attached thereto.

Typically, work in a yard, especially work to remove weeds, unwanted grass, plants, and the like, often requires the worker to kneel or lean over in an awkward position. This may cause strain to the worker's back, knees and other joints.

Many conventional gardening tools require swinging or pulling motions to accomplish work, such as weeding. Other tools may include a straight blade attached to a handle. To chop weeds at the roots, these tools are inserted into the ground at an angle by the user bending over to achieve the proper angle for weed removal.

As can be seen, there is a need for a tool for removing weeds, unwanted grass, plants, and the like from a yard while minimizing strain on the user.

### SUMMARY OF THE INVENTION

In one aspect of the present invention, a device comprises a handle; and a blade attached to the handle, the blade including a flat portion and an elongated hole, wherein one end of the handle fits into the elongated hole; and the flat portion forms an angle from about 20 to about 70 degrees relative to the handle.

In another aspect of the present invention, a tool for scraping at or below the surface of the ground comprises an elongated handle having a tapered end; and a blade attached to the tapered end of the handle, the blade including a flat portion and an elongated hole, wherein the tapered end of the handle fits into the elongated hole; and the flat portion forms an angle of about 45 degrees relative to the handle.

These and other features, aspects and advantages of the present invention will become better understood with reference to the following drawings, description and claims.

### BRIEF DESCRIPTION OF THE DRAWINGS

FIG. 1 shows a perspective view of a tool according to an embodiment of the present invention;

FIG. 2 shows a side view of the tool of FIG. 1;

FIG. 3 shows top view of the tool of FIG. 1;

FIG. 4 shows a front view of the tool of FIG. 1;

FIG. 5 shows a perspective view of a tool according to another embodiment of the present invention;

FIG. 6 shows a method of attaching a handle onto a blade to make the tool of FIG. 1; and

FIG. 7 shows a cross-sectional view of the handle inserted into the blade as taken along line 7-7 of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a tool having a blade and a handle. The blade may be attached to a tapered handle through an elongated hole on the blade and may be secured with a screw. The tool may be useful in removing weeds, unwanted grass, plants, and the like. The tool of the present invention may use a pushing/sliding force, as compared with conventional tools using a swinging, pulling or chopping force. The blade may include a sharp edge that may cut through the ground with ease. The sharp edge of the blade may be disposed at an angle, relative to the handle to permit a continuous sliding motion of the blade through the ground.

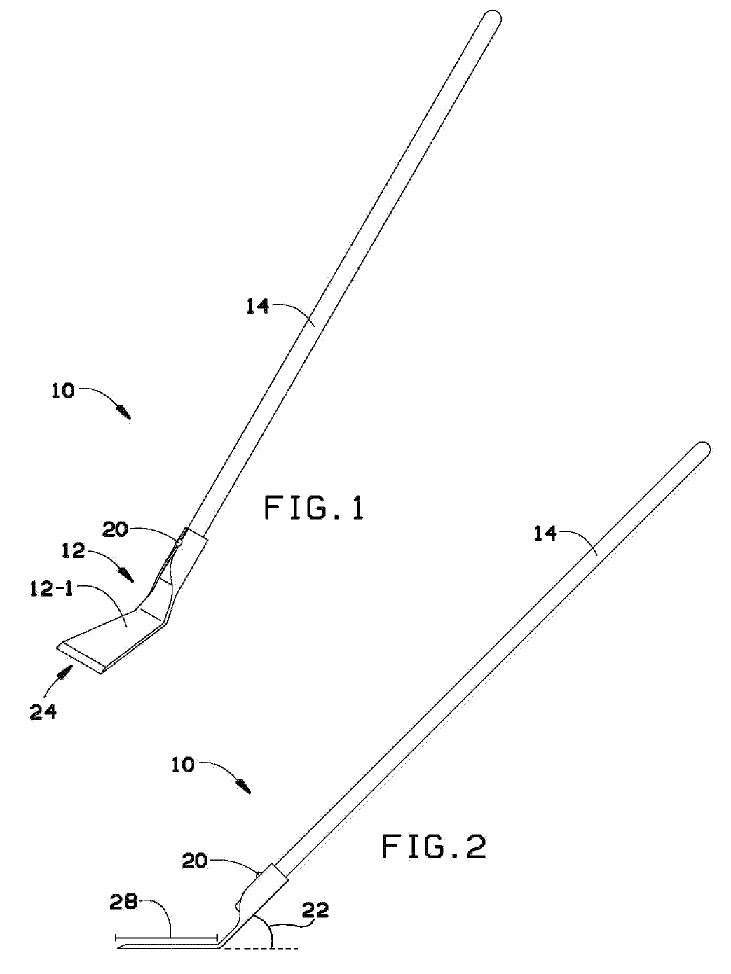

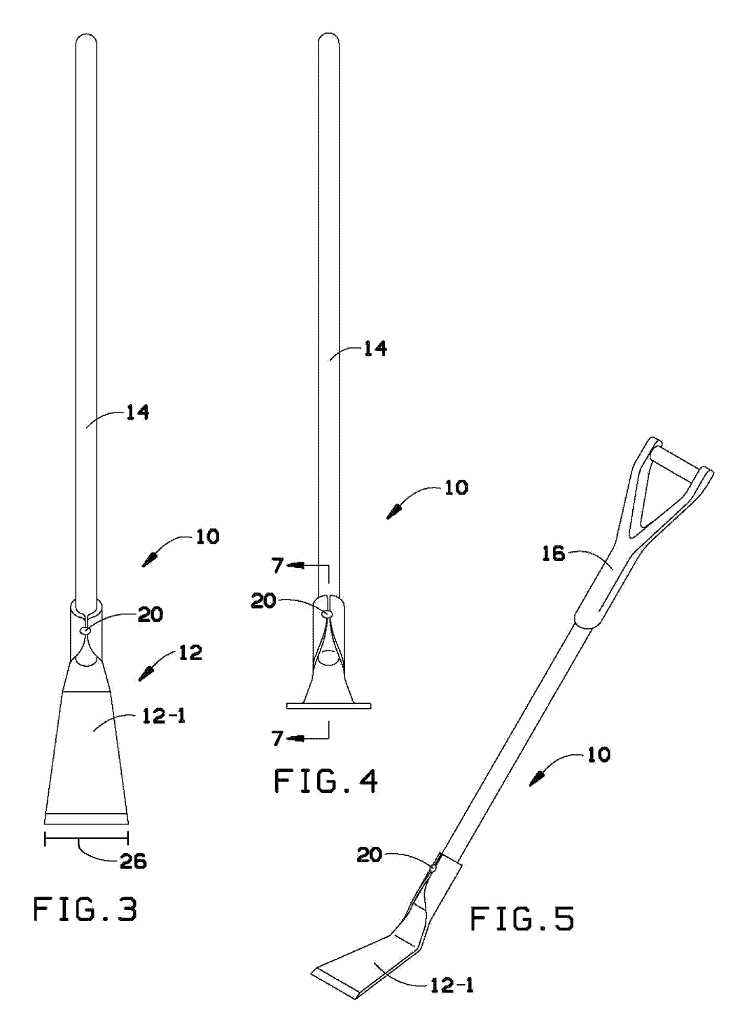

Referring to FIGS. 1 through 4, there is shown a tool 10 having a handle 14 attached to a blade 12. The blade 12 may include a sharp edge 24 that may cut through the ground. The sharp edge 24 of the blade may be disposed at one end of a flat portion 12-1 of the blade 12. The flat portion 12-1 may be at an angle 22, relative to the handle 14. The angle 22 may be between about 20 degrees to about 70 degrees, typically about 45 degrees.

The blade 12 may have a width 26 suitable for the desired task. For example, the width 26 may be wider for removing unwanted grass from a large surface area, wherein the width 26 may be narrower for weed removal. Typically, the width 26 may be between about 2 to about 4 inches, typically about 4 inches. The blade 12 may be made from any material of suitable strength for pushing the blade 12 through the ground. For example, the blade 12 may be made from steel having a thickness from about 5/16 to about ⅜ inch. The length 28 of the flat portion 12-1 of the blade 12 may be from about 4 to 12 inches, typically about 6 inches.

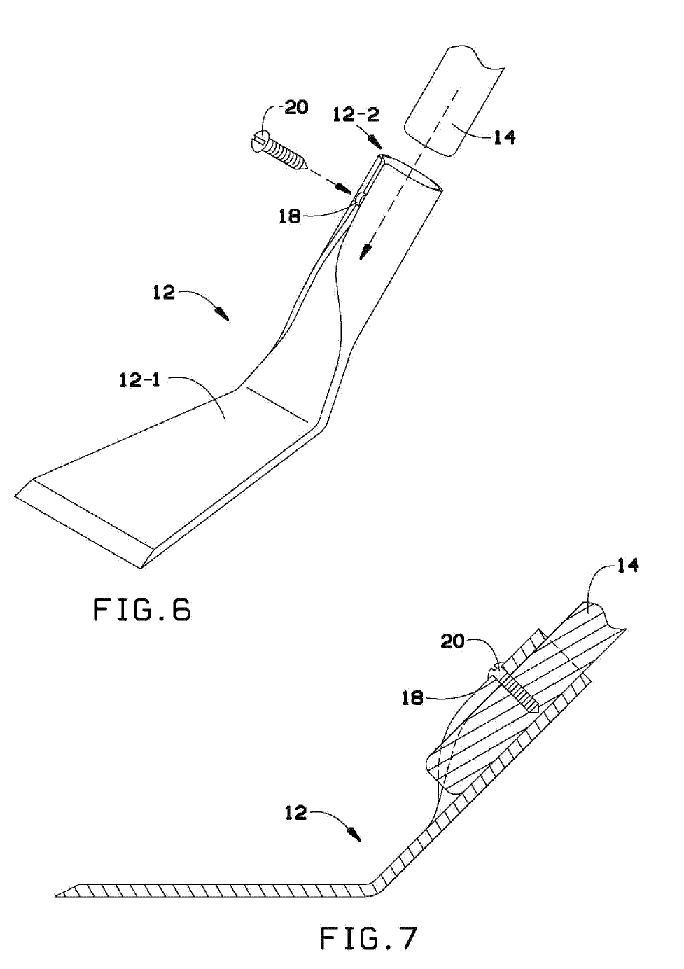

The handle 14 may attach to the blade 12 by any conventional means, including by inserting one end of the handle 14 into an elongated hole 12-2 formed integrally with the blade 12, as shown in FIGS. 6 and 7. A screw 20 may be inserted through a hole 18 in the blade 12 and into the handle 14. Alternatively, the handle may include standard handle male threads (not shown) that may thread into standard female handle threads (not shown) formed in the elongated hole 12-2.

The handle 14 may be made of a material used for conventional tool handles, such as wood, typically a hardwood such as ash, a composite material or fiberglass. The handle 14 may be from about 3 to 4.5 feet in length. In one embodiment of the present invention, as shown in FIG. 5, a grip 16, such as a conventional D-handle, may be attached at the distal end (relative to the blade 12) of the handle 14.

To use the tool 10 of the present invention, a user may simply grasp the handle 14 and slide the flat portion 12-1 of the blade 12 along the surface, or just under the surface, of the ground. The sharp edge 24 of the blade 12 may cut the roots of weeds, grasses and plants. A motion similar to that used with a push broom may be used to move the tool 10. The user may also use the tool 10 upside-down (as compared to the direction of FIG. 2). A swinging motion of the blade 12 of the tool 10 (upside-down) toward the ground may provide a chopping action to, for example, break surface vines and roots.

While the above describes the tool 10 used for gardening and landscaping, other uses of the tool 10 may be within the scope of the present invention. For example, the tool 10 may be used as a roof scraper, aiding in the removal of asphalt roof shingles. The tool 10 may also be used for tile removal, ice removal, or the like.

It should be understood, of course, that the foregoing relates to exemplary embodiments of the invention and that modifications may be made without departing from the spirit and scope of the invention as set forth in the following claims.

We claim:

1. A device comprising:
a handle; and
a blade attached to the handle, the blade including a flat portion and an elongated hole, wherein
one end of the handle fits into the elongated hole; and
the flat portion forms an angle from about 20 to about 70 degrees relative to the handle.

2. The device of claim 1, wherein the angle is about 45 degrees.

3. The device of claim 1, wherein the handle is an elongated handle having a taper at the one end that fits into the elongated hole.

4. The device of claim 1, wherein the blade has a sharp edge with a width from about 2 to about 5 inches.

5. The device of claim 1, wherein the width is about 4 inches.

6. The device of claim 1, wherein the flat portion of the blade has a length from about 4 to about 12 inches.

7. The device of claim 1, further comprising a grip at an other end of the handle.

8. A tool for scraping at or below the surface of the ground, the tool comprising:
an elongated handle having a tapered end; and
a blade attached to the tapered end of the handle, the blade including a flat portion and an elongated hole, wherein
the tapered end of the handle fits into the elongated hole; and
the flat portion forms an angle of about 45 degrees relative to the handle.

9. The tool of claim 8, wherein the blade has a sharp edge with a width of about 4 inches.

10. The tool of claim 1, wherein the flat portion of the blade has a length of about 6 inches.
